(19) United States
(12) Patent Application Publication
(10) Pub. No.: US 2008/0302787 A1
(43) Pub. Date: Dec. 11, 2008

(54) Vessel, Heating Apparatus and Method of Heating a Feedstock

(76) Inventors: William Robertson Cunningham Erskine, Aberdeenshire (GB); Anthony Revell, Victoria (AU)

Correspondence Address: BARNES & THORNBURG LLP, P.O. BOX 2786, CHICAGO, IL, 60690-2786, US

(21) Appl. No.: 11/995,420

(22) PCT Filed: Jul. 11, 2006
(86) PCT No.: PCT/GB06/02535

§ 371 Date: Jul. 31, 2008

(30) Foreign Application Priority Data
Jul. 11, 2005 (GB) 0514095.9

(51) Int. Cl. H05B 6/64

(52) U.S. Cl. 219/679

(57) ABSTRACT

A vessel (10) for a feedstock that is to be heated using radio frequency electromagnetic radiation (EMR), the vessel being adapted for rotation about an axis that passes through the vessel and having an inlet aperture through which the feedstock may be introduced into the vessel and a wall (16) for retaining the feedstock in the vessel, wherein the wall (16) has at least one vent for venting gases released by the feedstock, the at least one vent being so formed that rotation of the vessel about the axis prevents the feedstock from entering the vent, thereby retaining the feedstock in the vessel. Also heating apparatus (50) comprising such a vessel (10), means (54) for introducing a feedstock into the vessel, means (56, 62, 64, 66) for discharging the feedstock from the vessel, a source (58, 80) of EMR and drive means (75, 200, 202) operable to rotate the vessel (10) about an axis that passes through the vessel. Also a method of heating a feedstock using EMR, comprising the steps of delivering a feedstock into such a vessel, directing EMR at and/or introducing EMR into the vessel and rotating the vessel so as to tumble the feedstock.

### FIELD OF THE INVENTION

This invention relates to a vessel for a feedstock that is to be heated using radio frequency electromagnetic radiation (EMR), to heating apparatus that includes such a vessel and to a method of heating a feedstock using such a vessel.

### BACKGROUND TO THE INVENTION

It is well known to heat a feedstock using radio frequency electromagnetic radiation (EMR).

A known vessel for a feedstock that is to be heated using EMR consists of a tube that is substantially transparent to EMR, such that EMR directed at the tube passes through a wall of the tube into the feedstock inside the tube.

Heating of the feedstock by the EMR causes gases to be released from the feedstock, which gases must be extracted from the ends of the tube. Until the gases are extracted from the ends of the tube, they absorb a portion of the EMR directed at the tube, which portion of the EMR is prevented from reaching the feedstock. Heating a feedstock inside the known vessel using EMR is therefore less efficient than it might otherwise be, because of the portion of the EMR that heats the gases released from the feedstock rather than the feedstock itself.

### SUMMARY OF THE INVENTION

According to a first aspect of the invention there is provided a vessel for a feedstock that is to be heated using radio frequency electromagnetic radiation (EMR), the vessel being adapted for rotation about an axis that passes through the vessel and having an inlet aperture through which the feedstock may be introduced into the vessel and a wall for retaining the feedstock in the vessel, wherein the wall has at least one vent for venting gases released by the feedstock, the at least one vent being so formed that rotation of the vessel about the axis prevents the feedstock from entering the vent, thereby retaining the feedstock in the vessel.

The invention can provide a vessel that enables a feedstock to be heated using EMR more efficiently than the known vessel, because gases released from the feedstock can be vented from the vessel as soon as they are released from the feedstock such that EMR that would otherwise heat the gases instead heats the feedstock.

In this specification the expression “radio frequency” is intended to encompass frequencies of 10 kHz and higher.

The feedstock forms a bed near to the lowest part of the vessel and the rotation of the vessel agitates the bed. Where the feedstock is capable of absorbing the EMR, that portion of the feedstock which forms the upper surface of the bed absorbs most of the EMR. The agitation of the bed ensures that all parts of the feedstock form the upper surface of the bed at some stage, such that the heating of the feedstock is relatively uniform. Where the feedstock is incapable of absorbing the EMR, the vessel may be heated by absorption of the EMR, and that portion of the feedstock which forms the lower surface of the bed heated by contact with the vessel. The agitation of the bed ensures that all parts of the feedstock form the lower surface of the bed at some stage, such that the heating of the feedstock is relatively uniform.

The vessel may advantageously be substantially transparent to the EMR. This may be useful where the vessel is to be used for heating feedstocks that are capable of absorbing the EMR because the EMR does not need to be introduced into the vessel but can simply pass through the wall of the vessel and be absorbed by the feedstock. Of course, the vessel must then be enclosed by a shield to protect the surroundings of the vessel from the EMR.

Alternatively, the vessel may advantageously be substantially opaque to the EMR. This may be useful where the vessel is to be used for heating feedstocks that are incapable of absorbing the EMR because the EMR does not need to be introduced into the vessel but can simply be directed at and absorbed by the wall of the vessel and the feedstock heated by contact with the wall of the vessel. Again, the vessel must be enclosed by a shield. Where a vessel that is substantially opaque to the EMR is used to heat a feedstock that is capable of absorbing the EMR it may nonetheless be useful to introduce the EMR into the vessel so as to heat the feedstock both by absorption of the EMR and by contact with the wall of the vessel.

Preferably the vessel is substantially reflective to the EMR. This is useful where the vessel is to be used for heating feedstocks that are capable of absorbing the EMR because although the EMR must be introduced into the vessel, all of the EMR is absorbed by the feedstock rather than the vessel, which is more efficient than heating the feedstock by contact with the wall of the vessel.

The wall of the vessel may advantageously be provided with at least one portion that is capable of absorbing the EMR. The feedstock may then be heated by contact with the at least one portion.

Alternatively or in addition, the vessel may advantageously further comprise at least one heater.

Although the at least one heater may for example be adapted to receive a heated fluid, such as heated oil or steam, preferably the at least one heater is an electric heater.

The at least one portion and/or the at least one heater can be used to heat a feedstock that is incapable of absorbing the EMR in a vessel that is substantially reflective to the EMR, or can be used to establish one or more regions of relatively high temperature inside a vessel that is substantially transparent, opaque or reflective to the EMR.

Moreover, certain feedstocks have been found to be incapable of absorbing the EMR at room temperature, but capable of absorbing the EMR at elevated temperatures. The at least one portion and/or the at least one heater can therefore be used to heat such feedstocks to the elevated temperatures at which they are capable of absorbing the EMR, after which they can be heated by the EMR.

For example, where the feedstock includes oil, it has been found that heating of the feedstock from room temperature to 120 to 140° C. increases the absorption of microwaves by the feedstock by 30%.

The vessel is preferably generally cylindrical, having a generally tubular side wall and first and second generally circular end walls.

Preferably the vessel is adapted for rotation about an axis that passes through the centres of the first and second generally circular end walls.

Preferably the inlet aperture is formed in the first end wall.

Where the vessel is provided only with the inlet aperture the vessel must be operated in a batch mode, whereby the feedstock is introduced into the vessel though the inlet aperture, heated, then discharged from the vessel though the inlet aperture or through the at least one vent.

Preferably, therefore, the vessel is provided with an outlet aperture through which the feedstock may be discharged from the vessel. This enables the vessel to be operated in a continuous mode, whereby the feedstock is introduced into the vessel through the inlet aperture, heated, then discharged from the vessel through the outlet aperture.

In the preferred embodiment the outlet aperture is formed in the second end wall.

Preferably the at least one vent is formed in the side wall.

Preferably the side wall has a plurality of vents.

The vessel may advantageously comprise a side wall constituted by a single wall element secured between first and second support members constituted by respective first and second end walls and the at least one vent be formed in the single wall element. This construction makes the vessel relatively simple to assemble.

Preferably the vessel comprises a side wall constituted by a plurality of wall elements secured between first and second support members constituted by respective first and second end walls and at least some of the plurality of vents are formed between the plurality of wall elements.

Preferably the plurality of wall elements are substantially identical.

Although this construction makes the vessel more complicated to assemble, it makes the vessel easier to maintain, because if a wall element is damaged, it can simply be removed from between the support members and replaced.

Preferably the plurality of wall elements are slats formed with tabs and are secured between the end walls by engagement of the tabs with slots in the end walls.

Preferably the plurality of slats are secured between the end walls such that each wall element overlaps a neighbouring wall element to form an elongate vent between a portion of each slat and an overlapping portion of a neighbouring slat.

Of course, with this construction of the vessel it is important that the vessel is rotated in the correct sense to retain the feedstock in the vessel, because rotation of the vessel in the opposite sense will cause the feedstock to escape from the vessel between the slats.

In this connection it is envisaged that a typical feedstock would be substantially composed of particulate solids.

Preferably the slats are secured between the end walls such that the width of each elongate vent (as opposed to the length) is no more than one quarter of a wavelength of the EMR so that the vent forms a choke that attenuates the EMR.

In this way the elongate vents can vent the gases released from the feedstock but the EMR is substantially prevented from escaping from the vessel through the vents.

The wall element or elements may advantageously be formed from a metal.

It is relatively straightforward to form the at least one wall element from a metal. However, metals that lend themselves to forming the wall element or elements are generally relatively soft and likely to be abraded by the feedstock as the vessel is rotated, or attacked by corrosive feedstocks.

Preferably, therefore, the wall element or elements is/are formed from a ceramic material.

It is much more difficult to form the wall element or elements from a ceramic material, but ceramic materials are much harder wearing and resistant to attack by corrosive feedstocks than most metals.

Preferably the slats are formed from steel and ceramic panels attached to the surfaces of the slats that come into contact with the feedstock.

In this way all the benefits of ease of forming of a metal and durability and resistance to chemical attack of a ceramic are obtained.

In a preferred embodiment of the invention a rail extends along each slat and constitutes a tenon, and each ceramic panel is formed with a slot that constitutes a mortise, each ceramic panel being fastened to a slat by engagement of the slot with the rail.

In the preferred embodiment three rails extend along each slat and three rows of ceramic panels are fastened to each slat by engagement of the slot of each panel with one of the rails.

The wall element or elements may advantageously be provided with one or more generally radially inwardly directed blades adapted to lift the feedstock as the vessel is rotated, so as to tumble the feedstock.

Preferably the one or more blades is/are angled relative to the axis of rotation of the vessel so as to cause a movement of the feedstock from the first end wall of the vessel towards the second end wall as the vessel is rotated, as well as tumbling the feedstock.

The one or more blades may advantageously be pivotally attached to the wall element or elements so as to enable the angle of the blade or blades to the axis of rotation of the vessel to be adjusted.

In this way the speed at which the feedstock moves along the vessel can be adjusted.

Where the wall element or elements are provided with a plurality of blades, the angles of the blades to the axis of rotation of the vessel may be varied along the vessel so as to cause the feedstock to move at different speeds, or even dwell, in different regions along the vessel.

This has the effect of varying the depth of the bed of the feedstock along the vessel, and can be used to control the temperature rise of the feedstock as it moves through the vessel.

The slats may advantageously be formed with a plurality of apertures, each aperture forming another of the plurality of vents and having a greatest dimension of no more than one quarter of a wavelength of the EMR.

In addition to venting gases released by the feedstock from the vessel, the plurality of apertures substantially prevent EMR from escaping through them from the vessel whilst reducing the mass of the slats.

Where the vessel includes the at least one heater, the at least one heater is preferably attached to an exterior face of a slat and the plurality of apertures located in the slat so as to facilitate transmission of infra-red radiation through the slat into the vessel.

For example, where the at least one heater is a heater strip, comprising a metal heating element embedded in a strip of a ceramic material, the plurality of apertures would be located so as to overlie the metal heating element.

Obviously, where the ceramic tiles are attached to the slats, the apertures covered by the ceramic files cannot vent gases released from the feedstock from the vessel.

Nevertheless, these apertures can substantially prevent EMR from escaping through them from the vessel whilst reducing the mass of the slats, as well as allowing infra-red radiation from a source of infra-red radiation outside the vessel to pass through them into the vessel so as to heat the feedstock.

It will be appreciated that, where the at least one heater is a heater strip, comprising a metal heating element embedded in a strip of ceramic material, the heater strip can be set into that face of one of the ceramic panels which comes into contact with the feedstock. In that case the plurality of apertures formed in the slats would be unnecessary, except to reduce the mass of the vessel, because there would be no need to transmit infra-red radiation from the exterior to the interior of the vessel.

According to a second aspect of the invention there is provided heating apparatus comprising a vessel according to the first aspect of the invention, means for introducing a feedstock into the vessel, means for discharging the feedstock from the vessel, a source of EMR and drive means operable to rotate the vessel about an axis that passes through the vessel.

The source of EMR may advantageously be operable to generate EMR with a frequency in the range 500 MHz to 3 THz.

The source of EMR may advantageously be operable to generate EMR with a frequency of 2.46 GHz. This frequency is suitable for heating feedstocks containing water.

Alternatively or in addition, the source of EMR may advantageously be operable to generate EMR with a frequency of 895 MHz. This frequency is suitable for feedstocks containing oil.

The means for introducing the feedstock into the vessel may advantageously comprise a tube of a slightly smaller external diameter than a diameter of the inlet aperture of the vessel, the tube being arranged so as to be coaxial with the axis of rotation of the vessel and the drive means being operable to rotate the vessel relative to the tube.

The means for discharging the feedstock from the vessel preferably comprises a tubular extension attached to the second end of the vessel so as to communicate with the outlet aperture, and a cylindrical drum with a radially outwardly directed nozzle, the drum being open at one end to receive the tubular extension, which rotates with the vessel relative to the drum, and the nozzle of the drum being directed downwards such that the feedstock can exit the vessel through the tubular extension, enter the drum and be discharged through the nozzle of the drum.

The apparatus may advantageously include a further vessel according to the first aspect of the invention, the first end of the further vessel being attached to the second end of the vessel such that the axis of rotation of the further vessel is collinear with the axis of rotation of the vessel.

The source of EMR may advantageously include a waveguide for introducing the EMR into the vessel.

Preferably the waveguide is a slotted waveguide and is attached to, and passes through, the other end of the drum to enter the vessel through the outlet aperture, the waveguide extending along substantially the entire length of the vessel or vessels.

The source of EMR may advantageously include a microwave horn that is attached to, and passes through, the other end of the drum to enter the vessel through the outlet aperture, the horn extending a short distance into the vessel.

The microwave horn is particularly useful where the feedstock is wood chips that are to be dried. This is because the microwave horn directs most of the EMR towards the inlet end of the vessel, so that most of the EMR is absorbed by the damp wood chips entering the vessel, with the result that the dried wood chips towards the outlet end of the vessel do not overheat.

The apparatus may advantageously further comprise a source of infra-red radiation.

Preferably the source of the infra-red radiation extends along substantially the entire length of the vessel or vessels.

It has been found that certain feedstocks are incapable of absorbing the EMR at room temperature, but are capable of absorbing the EMR at elevated temperatures. Where the apparatus is to be used to heat such a feedstock, infra-red radiation can be directed at the vessel to heat the vessel and, where the slats of the vessel are provided with the plurality of apertures to admit the infra-red radiation, to heat the feedstock, to the elevated temperature at which the feedstock is capable of absorbing the EMR.

The apparatus is preferably configured to receive the vessel in a substantially horizontal orientation, such that the axis of the vessel is substantially parallel to a surface on which the apparatus rests.

However, the apparatus is preferably further provided with adjustment means for adjusting an angle of inclination of the axis of the vessel to the surface on which the apparatus rests.

By adjustment of the angle of inclination of the axis of the vessel, a speed at which the feedstock travels through the vessel can be controlled. That is, by raising the first end of the vessel relative to the second end, the speed at which the feedstock travels through the vessel is increased, and by raising the second end of the vessel relative to the first end, the speed at which the feedstock travels through the vessel is decreased. Typically the adjustment means is operable to adjust the angle of inclination of the vessel by up to 10 degrees.

The apparatus may advantageously include suction means for collecting gases vented from the vessel.

Preferably the apparatus includes a plurality of suction means arranged to collect gases vented from different regions of the vessel.

This is useful where the composition of the gases released from the feedstock changes as the feedstock progresses along the vessel, because it enables the gases released from the feedstock to be separated by composition.

For example, in the case of oily cuttings cleaning (oily cuttings are a by-product of oil drilling) when the oily cuttings are heated, first steam is released as water in the cuttings is evaporated then oil vapour is released as the oil in the cuttings is evaporated. By placing a first suction means along that portion of the vessel in which mainly steam is released from the oily cuttings, and a second suction means along that portion of the vessel in which mainly oil vapour is released from the oily cuttings, the gases released from the oily cuttings can easily be separated into mostly steam and mostly oil vapour.

The apparatus may advantageously include means for pumping an inert gas into the vessel, so as to prevent combustion of the feedstock as it is heated.

Where the apparatus includes a plurality of suction means, the inert gas to be pumped into the vessel may advantageously be an inert gas collected by one of the plurality of suction means.

Again using the example of oily cuttings cleaning, steam released from the cuttings at the beginning of the heating process can be reintroduced into the vessel when oil vapour is being released from the cuttings, so as to prevent ignition of the oil vapour.

Similarly, oil vapour released from the cuttings can be burnt to generate electricity to run the apparatus.

Preferably the drive means is controllable such that the speed of rotation of the vessel can be varied. Typically the speed of rotation of the vessel would be variable between approximately 0.3 and 10 rpm.

The apparatus may advantageously further include a thermally insulated enclosure.

Preferably the enclosure is adapted to be sealable so as to form a substantially gas-tight seal around at least the vessel, waveguide and means for introducing and discharging the feedstock from the vessel.

According to a third aspect of the invention there is provided a method of heating a feedstock using EMR, the method comprising the steps of delivering a feedstock into a vessel according to the first aspect of the invention, directing EMR at and/or introducing EMR into the vessel and rotating the vessel so as to tumble the feedstock.

Where the feedstock does not interact with the EMR, the method may advantageously further include the step of delivering into the vessel a material that interacts with the EMR.

Preferably the material is delivered in the form of briquettes that are mixed with the feedstock by the rotation of the vessel.

The method may advantageously further comprise the step of directing infra-red radiation at the exterior of the vessel.

Alternatively or in addition, the method may advantageously further comprise the step of supplying a heated fluid or electric current from a source of heated fluid or electric current through a rotary union to a heater attached to the vessel.

The method may advantageously still further comprise the step of pumping an inert gas into the vessel so as to prevent combustion of the feedstock.

Where the heating of the feedstock causes the feedstock to release flammable gases, the method preferably includes the step of collecting the gases and burning them in a boiler or gas turbine to drive an electric generator.

With certain feedstocks, therefore, such as oily cuttings the heating of the feedstock causes hydrocarbon gases to be released from the feedstock, which gases can be used to generate sufficient electrical energy to operate the apparatus used to carry out the method.

### BRIEF DESCRIPTION OF THE DRAWING FIGURES

The invention will now be described in greater detail with reference to the attached drawing figures, in which:

FIG. 1 is a perspective view of a vessel in accordance with the first aspect of the invention;

FIG. 2 is a perspective view of part of the vessel of FIG. 1;

FIGS. 3a, 3b and 3c are end, top and side views, respectively, of one of the slats of the vessel of FIGS. 1 and 2;

FIG. 4 is a perspective view of part of a side wall of the vessel of FIGS. 1 to 3;

FIG. 5 is a perspective view of heating apparatus in accordance with the second aspect of the invention;

FIG. 6 is a perspective view of part of the apparatus of FIG. 5;

FIG. 7 is a perspective view of the drum of the apparatus of FIG. 5;

FIG. 8 is an end view of part of the apparatus of FIG. 5;

FIGS. 9 and 10 are perspective views of the apparatus of FIG. 5 in a thermally insulated enclosure;

FIGS. 11a, 11b and 11c are end, top and side views, respectively, of a preferred form of slat;

FIG. 12 is a schematic sectional view of part of a vessel formed from the slats of FIG. 11;

FIGS. 13a, 13b and 13c are schematic end views of a preferred form of ceramic tile, a portion of a slat, and the ceramic tile attached to the portion of the slat, respectively;

FIG. 14 is an enlarged detail of FIG. 13c; and

FIGS. 15a and 15b are a perspective view, and an end view, respectively, of a preferred form of enclosure.

### DETAILED DESCRIPTION OF AN EMBODIMENT

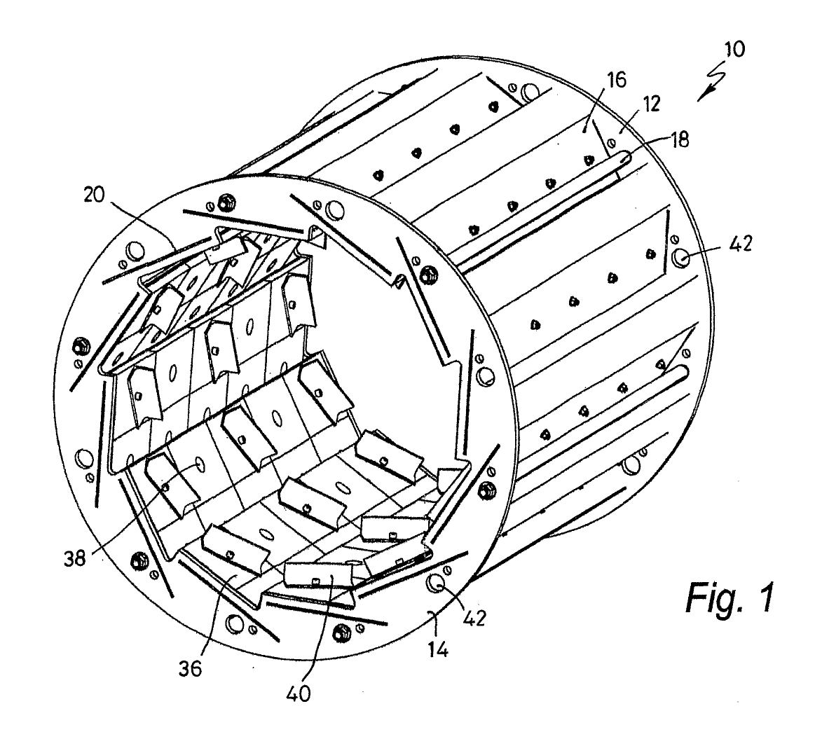

The vessel 10 of FIG. 1 comprises first and second end walls 12 and 14, and twelve slats 16 secured between the end walls 12 and 14 by six tie rods 18 so as to form a side wall of the vessel. The ends of each slat 16 are formed with tabs that engage with slots 20 in the end walls 12 and 14.

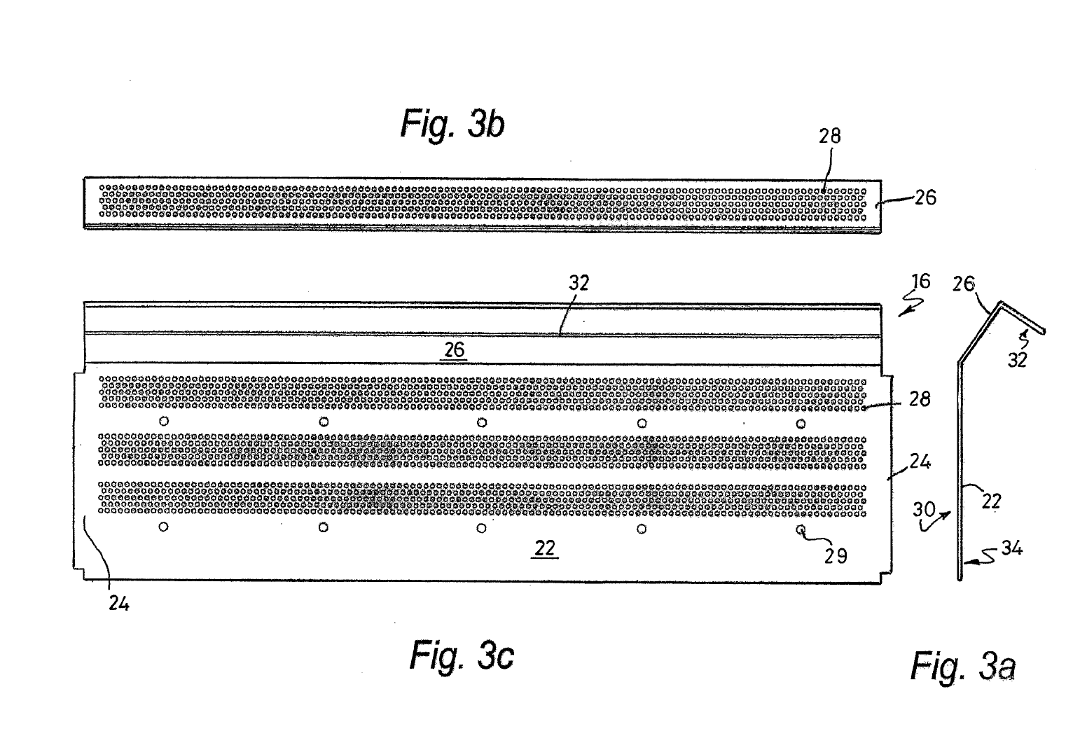

Turning briefly to FIGS. 3a, 3b and 3c, each slat 16 consists of a wide flat portion 22 at the ends of which the tabs 24 are formed, and right-angled lip portion 26 which extends from one edge of the wide flat portion 22. The portions 22 and 26 are formed with a large number of 4 mm diameter circular holes 28 with a pitch of 6.5 mm between the centres of adjacent holes. The portion 22 has 10 larger diameter bolt holes 29 arranged in two lines of five holes.

The slats 16 are secured between the end walls 12 and 14 such that a slot of approximately 1 mm width is formed between an outer surface 30 of the wide flat portion 22 of each slat 16 and the edge 32 of the lip portion 26 of a neighbouring slat 16.

Returning to FIG. 1, ten square ceramic tiles 36 are attached to an inner surface 34 of each slat 16 by means of bolts and the bolt holes 29. The heads of seven of the ten bolts used to attach the tiles to the slats are accommodated in sockets, the heads of the bolts being protected by plugs 38 that fit into the sockets over the bolt heads.

The remaining three bolts are also used to attach a right-angled fin 40 to three of the tiles, the fins serving to lift the feedstock as the vessel is rotated, so as to tumble the feedstock. The fins 40 are attached to their respective tiles 36 so that the edge of each fin forms an angle of approximately 45 degrees to the edge of its respective slat. This angle ensures that as the vessel is rotated, the feedstock is moved from the first end of the vessel towards the second end.

The first and second end walls 12 and 14 are formed with six holes 42 disposed equidistantly around the periphery of the end wall. The holes 42 enable a further vessel to be bolted to either end wall of the vessel to double the length of the vessel.

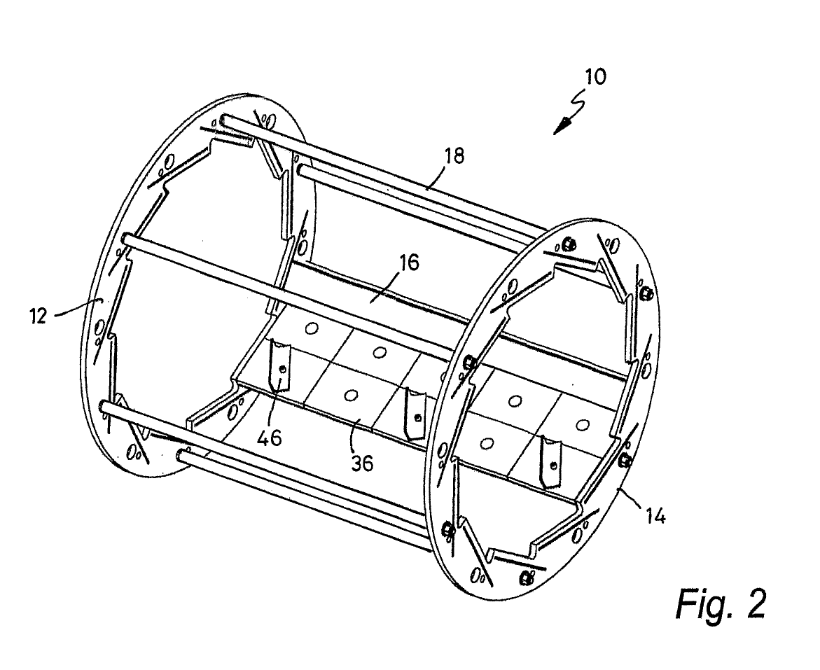

FIG. 2 shows the first and second end walls 12 and 14, a single slat 16, the six tie rods 18, ten tiles 36 attached to the inner surface of the slat and three fins 40 attached to three of the tiles 36.

The end walls 12 and 14, slat 16 and fins 40 are made from 3 mm thickness stainless steel sheet and the tiles 36 are made from sintered alumina.

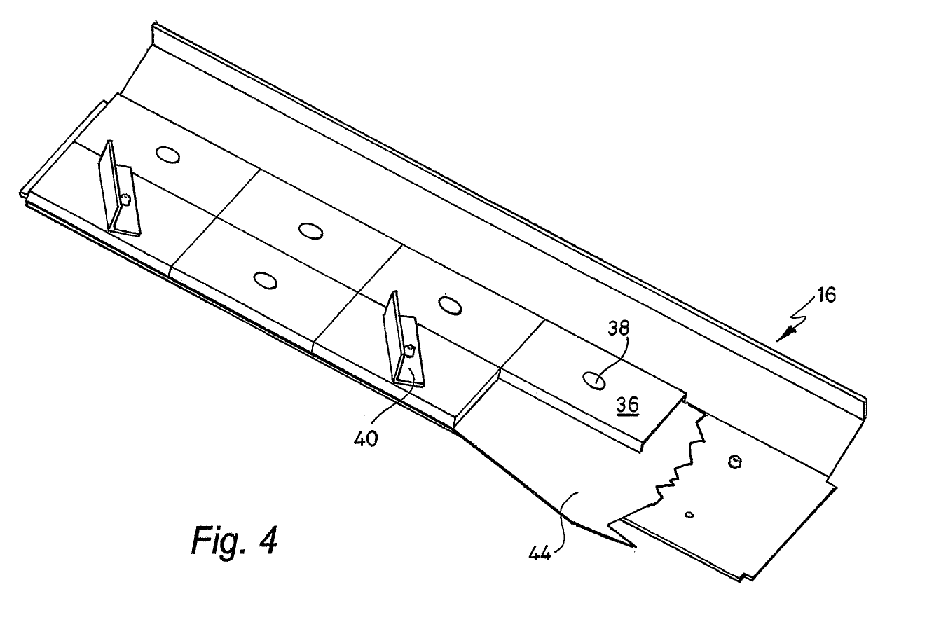

Turning to FIG. 4, this shows one of the slats 16 with seven ceramic tiles 36 attached and two fins 40. A needle mat pad 44 is interposed between the inner surface of the slat 16 and the ceramic tiles, which prevents vibration of the tiles during rotation of the vessel.

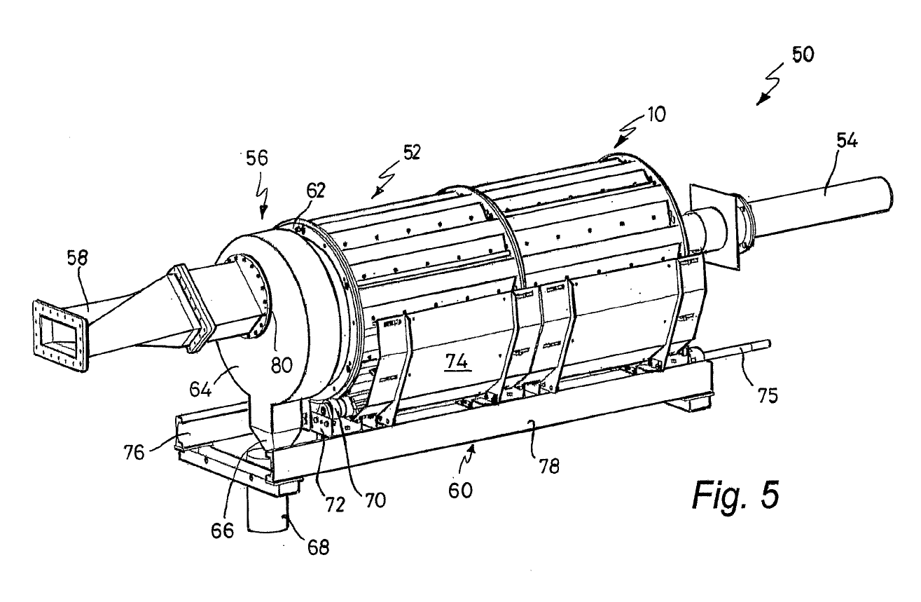

FIG. 5 shows heating apparatus 50 comprising the vessel 10, a further vessel 52, means 54 for introducing the feedstock into the vessel 10, means 56 for discharging the feedstock from the further vessel 52, a waveguide 58 and a cradle 60 for supporting and rotating the vessel.

The first end of the further vessel 52 is attached to the second end of the vessel 10 by bolts through the holes 42 of the second end wall 14 of the vessel 10 and corresponding holes in the first end wall of the further vessel 52, such that the vessel 10 and further vessel 52 form a single, continuous vessel.

Although the single, continuous vessel is shown as being constituted by the two vessels 10 and 52, it is to be appreciated that a single, continuous vessel could be constituted by any number of vessels such as 10 and 52 without limit.

The means 54 for introducing the feedstock into the vessel 10 comprises a tube that is arranged to be coaxial with the axis of rotation of the vessel 10 and 52 and projects a short distance into the first end of the vessel 10 through a circular aperture in the end wall 12. The diameter of the circular aperture is slightly greater than the external diameter of the tube so that the vessels 10 and 52 can rotate relative to the tube.

The means 58 for discharging the feedstock from the further vessel 52 comprises a tubular extension 62 that is bolted to the second end wall of the further vessel 52 and rotates with the vessel, a cylindrical drum 64 that is of a slightly greater internal diameter than the external diameter of the tubular extension 62 and is open at one end to accommodate the tubular extension 62, and a nozzle 66 that projects radially outwardly from a side wall of the drum 64. The drum is bolted to the cradle 60 such that the tubular extension 62 projects into the drum 64 through the open end of the drum and is accommodated inside the drum, and the nozzle 66 is directed downwards. A tube 68 is arranged beneath the nozzle 66 to receive the feedstock discharged from the nozzle. Movement of the feedstock along the vessels 10 and 52 as a result of rotation of the vessels and the operation of the fins 40 causes some of the feedstock eventually to enter the tubular extension 62 from the vessel 52. More of the feedstock entering the tubular extension 62 from the vessel 52 causes some of the feedstock in the tubular extension to fall from the tubular extension 62 into the drum 64. The feedstock in the drum (which does not rotate in operation of the apparatus) falls towards the nozzle 66, enters the nozzle and is discharged through the nozzle into the tube 68.

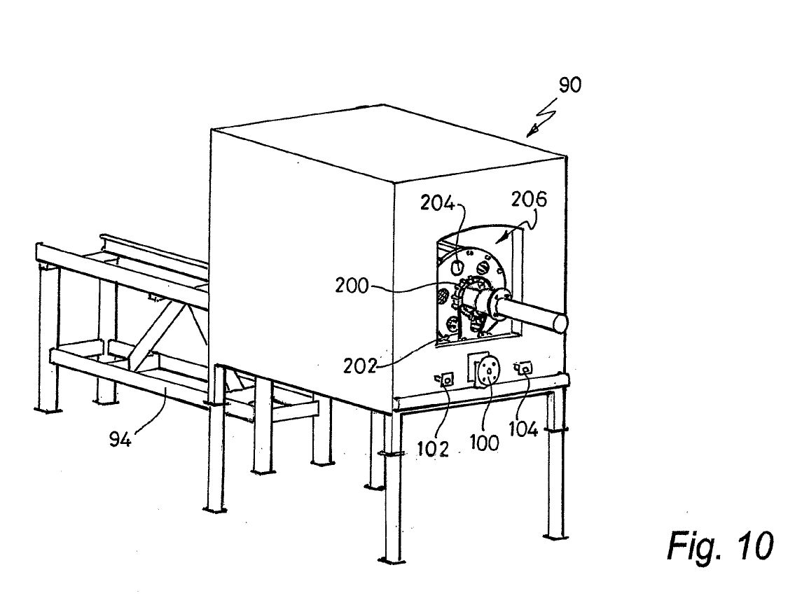

The cradle 60 comprises three pairs of grooved rollers, one of which is visible in FIG. 5 and is denoted by reference numeral 70, which are carried in a frame 72. The pairs of rollers are so located that one pair of rollers supports the rim of the first end wall 12 of the vessel 10, a second pair supports the rims of the second end wall 14 of the vessel 10 and first end wall of the vessel 52, and a third pair supports the rim of the second end wall of the vessel 52. A curved reflector panel 74 is attached to the frame 72 and extends for the entire length of the vessels 10 and 52. The reflector panel 74 carries three carbon infra-red radiation emitter tubes and ensures that infra-red radiation from the three tubes is directed at the vessels 10 and 52. The frame also carries a toothed drive wheel (not visible in FIG. 5) on a drive shaft 75 to which a shaft of an electric motor (not shown) can be coupled to rotate the drive wheel. The first end wall 12 of the vessel 10 has attached to it a toothed driven wheel, the centre of the wheel being arranged to lie on the axis of rotation of the vessels. The drive wheel is coupled to the driven wheel by means of a chain. Neither the driven wheel nor the chain is visible in FIG. 5, but both are visible in FIG. 10, denoted respectively by reference numerals 200 and 202. The frame is itself mounted on rollers (not visible in FIG. 5) that are received in runners 76 and 78 so that the frame and other components of the apparatus can be rolled in a direction parallel to the axis of rotation of the vessels relative to the runners 76 and 78.

This is useful where the apparatus is to be contained in an enclosure, because the runners can be attached to the enclosure and the frame and other components rolled into and out of the enclosure (by means of an extension to the runners 76 and 78) for inspection and maintenance of the apparatus. To this end the tube 54 is made up of two flanged lengths, the flanges being bolted together so as to join the two lengths, so that the two lengths can be separated and the apparatus rolled out of the enclosure in the direction of the further vessel 52 from the vessel 10.

The waveguide 58 is attached to the closed end of the drum 64 by means of a flanged portion 80. The closed end of the drum 64 is formed with an aperture that allows a portion (not visible in FIG. 5) of the waveguide 58 to extend through the drum 64 and inside the vessels 10 and 52 along almost the entire length of the vessels. In use, the vessels 10 and 52 rotate around the waveguide. The portion of the waveguide that extends inside the vessels is 2.1 m in length, 0.25 m in width and has a square cross section. The portion of the waveguide inside the vessels is formed with a series of slots in its underside, the slots extending perpendicularly to the axis of rotation of the vessels and serving to direct EMR towards the feedstock. The slots formed in the underside of the waveguide are not directed vertically downwards, but rather towards a region of the vessels a small distance around the side walls of the vessels in the direction of rotation of the vessels. This is because in use of the apparatus most of the feedstock occupies a region between the lowest part of the vessels and the region from which the feedstock spills from the fins 40 as the vessels rotate.

It is envisaged that instead of the waveguide 58 attached to the drum 64, several small apertures could be formed in the several of the slats of the vessels 10 and 52, the apertures each accommodating a magnetron operable to direct EMR into its respective vessel. Electrical energy and a liquid coolant would be supplied to each of the magnetrons by means of a rotary coupling attached to the end wall of one of the vessels. It is unimportant that the arrangement of magnetrons accommodated in apertures in the slats of the vessels do not direct the EMR at the feedstock at all times because the vessels act as resonant cavities in which the EMR is reflected by the interiors of the vessels until it is absorbed by the feedstock.

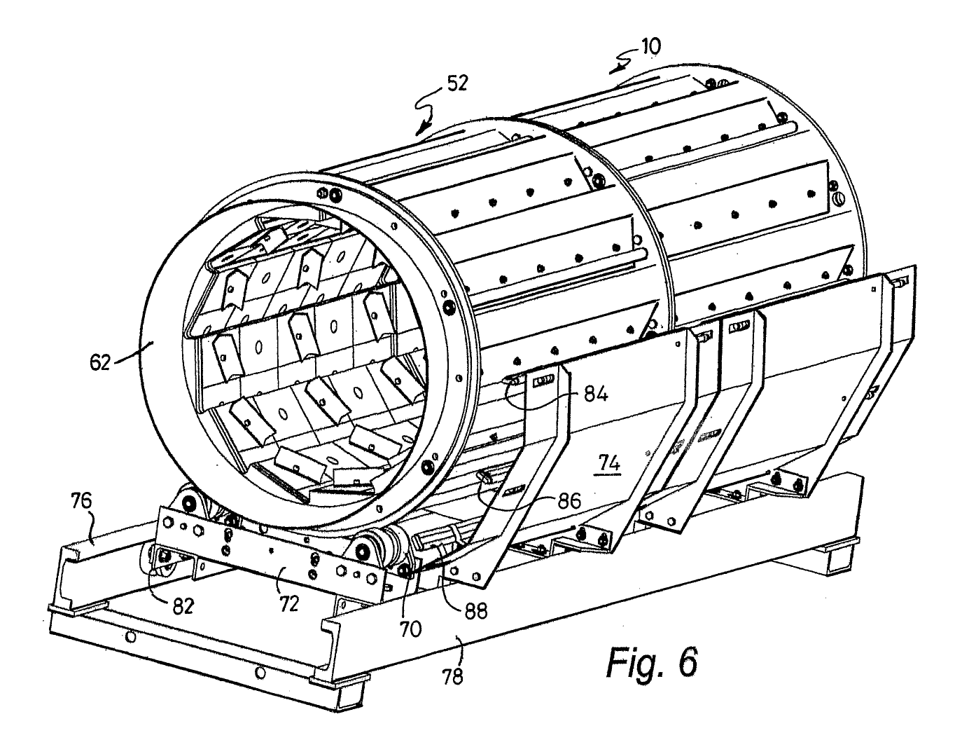

FIG. 6 shows the grooved rollers 70 of the frame and one of the rollers, denoted by reference numeral 82, that support the frame 72 in the runners 76 and 78. FIG. 6 also shows the three carbon infra-red radiation emitter tubes attached to the reflector 74. The emitter tubes are denoted by reference numerals 84, 86 and 88. Use of the emitter tubes is particularly beneficial where the apparatus is operated from cold, because the emitter tubes can be used to heat the apparatus to a minimum operating temperature before the EMR is introduced into the vessels. If the EMR were introduced into the vessels when the apparatus was still at room temperature, there is a chance that some of the gases released from the feedstock would condense on the slats of the vessels and perhaps foul the slots between the slats or the apertures formed in the slats.

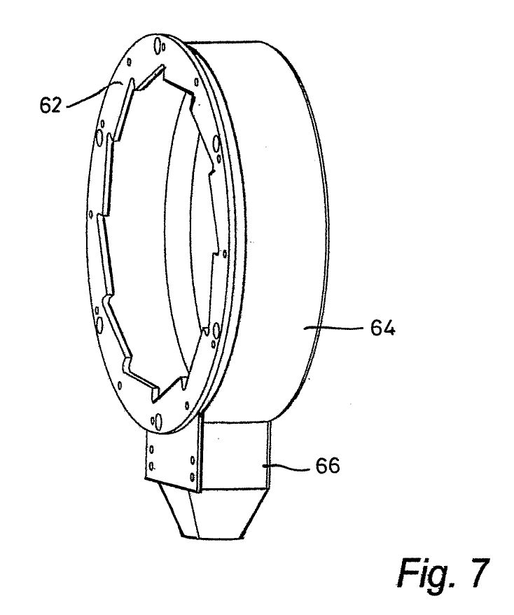

FIG. 7 shows the extension tube 62, drum 64 and nozzle 66. The extension tube 62 is, for the most part, accommodated within the drum 64.

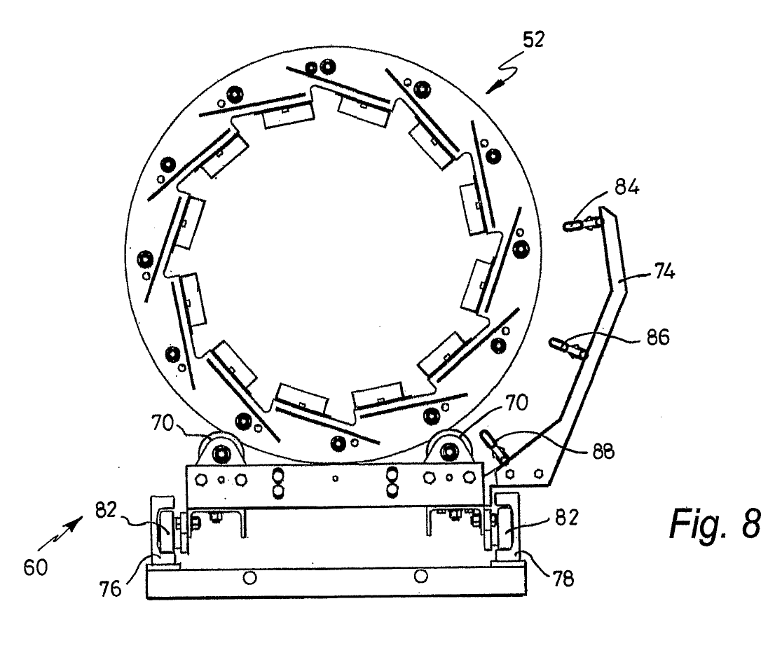

FIG. 8 is an end view of the second vessel 52 supported in the cradle 60. For the purpose of clarity, the extension tube 62, drum 64, nozzle 66 and waveguide 58 have been omitted.

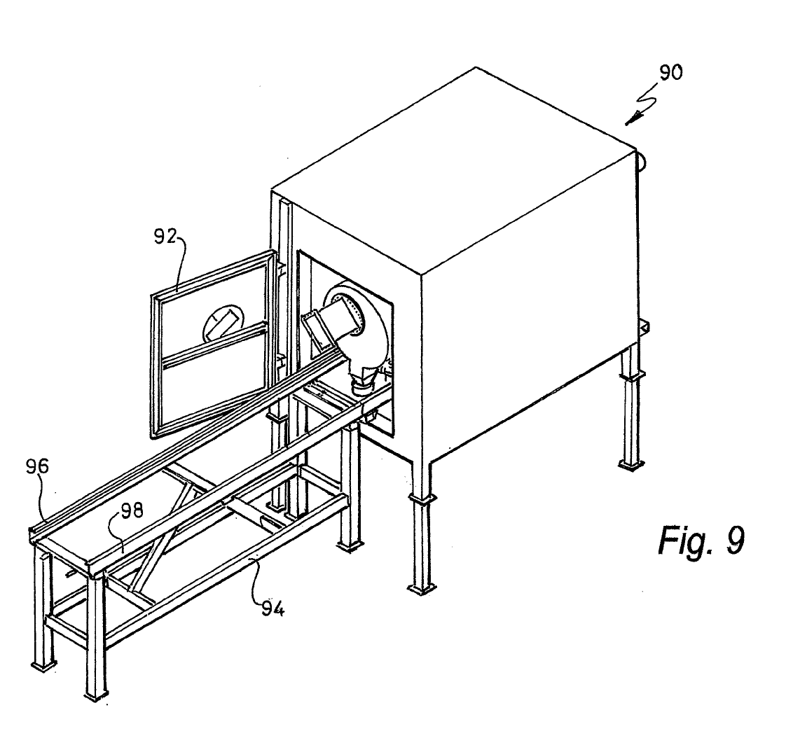

FIG. 9 shows the apparatus contained in an enclosure 90 which is made from 3 mm thickness steel sheet and thermally insulated. The construction of the vessels 10 and 52 ensures that more than ninety percent of the EMR introduced into the vessels is retained in the vessels. The enclosure 90 retains the small amount of EMR that escapes from the vessels and reduces heat loss from the apparatus. The enclosure 90 is provided with a door 92 covering an opening through which the apparatus may be rolled into and out of the enclosure. Also shown in FIG. 9 is a support structure 94 bearing runners 96 and 98. When the door 92 is opened the support structure may be placed against the opening normally covered by the door so that the runners 96 and 98 are aligned with the runners 76 and 78 and the apparatus rolled out of the enclosure to be supported on the support structure 94 for inspection or maintenance of the apparatus.

Turning to FIG. 10, this shows the opposite side of the enclosure 90. In FIG. 10 six circular holes are shown in the end wall 12 of the vessel 10; one such hole is denoted by reference numeral 204. The holes are shown for illustrative purposes only to afford a view of the interior of the vessel 10 and are not in fact present in the described embodiment. Similarly a window 206 is shown in the wall of the enclosure. This is also shown only for illustrative purposes and is not present in the described embodiment.

The drive shaft 75 of the apparatus passes through the wall of the enclosure and terminates in a flange 100 for attachment to a similar flange of a shaft of an electric motor located outside the enclosure 90. The electric motor and similar flange are not shown in FIG. 10. Two flanged pipes 102 and 104 pass through the wall of the enclosure and enable the interior of the enclosure to be connected either to a source of inert gas or to a pump for drawing gases released from the feedstock out of the enclosure. Use of such a pump increases the efficiency of the heating of the feedstock because the gases are drawn out of the vessels through the slots formed between the slats 16 and apertures 28 in the slats and so exit the vessels more quickly than if the interior of the enclosure were maintained at atmospheric pressure. In this way a greater proportion of the EMR introduced into the vessels is used to further heat the feedstock, rather than further heating the gases released from the feedstock.

Feedstocks that may be heated in the apparatus of the invention include contaminated activated carbon, which is a by-product of sugar refining, oily cuttings, which are a by-product of oil drilling, and wood chips, which are to be dried.

Contaminated activated carbon can be cleaned by heating in the apparatus because the heating of the activated carbon by the EMR vaporises the impurities in the activated carbon and the impurities can be extracted from the vessels leaving pure activated carbon, which can then be reused. Where the feedstock is contaminated activated carbon an inert gas must be introduced into the vessel to prevent combustion of the carbon. It has been found that a 12-15% concentration of nitrogen in the vessels prevents combustion of the carbon.

Operation of the apparatus is as follows. The carbon infra-red emitter tubes only are operated initially with the vessels rotating at around 3 revolutions per minute. The output of the tubes is controlled so that the temperature of the vessels increases by approximately 20° C. every 15 minutes until the vessels reach an operating temperature of approximately 200° C. The inert gas is then pumped through the enclosure. The feedstock is introduced into the vessels and the source of EMR switched on. The apparatus may then be operated continuously with operation from time to time, if necessary, of the emitter tubes to maintain the vessels at their operating temperature. A wide range of operating temperatures of the vessels are possible, from as low as 110° C. for drying woodchips up to 1000° C. for cleaning of contaminated carbon.

In a typical carbon cleaning operation the heating of the carbon would effectively occur in three zones. In the first zone the carbon would be heated to approximately 120° C. as water mixed with the carbon is evaporated. In the second zone the temperature of the carbon would rise to approximately 450° C. and the impurities mixed with the carbon are evaporated. In the third zone the carbon is heated to approximately 1000° C. to complete the cleaning of the carbon. The angle of the fins inside the vessels may be increased or decreased as necessary to either speed up or slow down the movement of the carbon through the vessels in the three zones. The effect of speeding up or slowing down the movement of the carbon is of course to reduce or increase the temperature rise of the carbon. It will be appreciated that the zones may be merely notional and defined only by the temperature of the carbon at a particular region of the vessels. However, the vessels may be divided into actual zones by using three vessels attached to one another, each vessel being operated at a different temperature from the other vessels, although some conduction will occur between vessels.

Instead of introducing nitrogen into the third zone, steam may instead be collected from the first zone, optionally superheated, then introduced into the third zone to prevent combustion of the carbon.

In the example given above of cleaning contaminated carbon, the carbon discharged from the nozzle of the drum is incandescent and it must be ensured that the carbon is discharged into water as soon as it leaves the inert atmosphere of the enclosure.

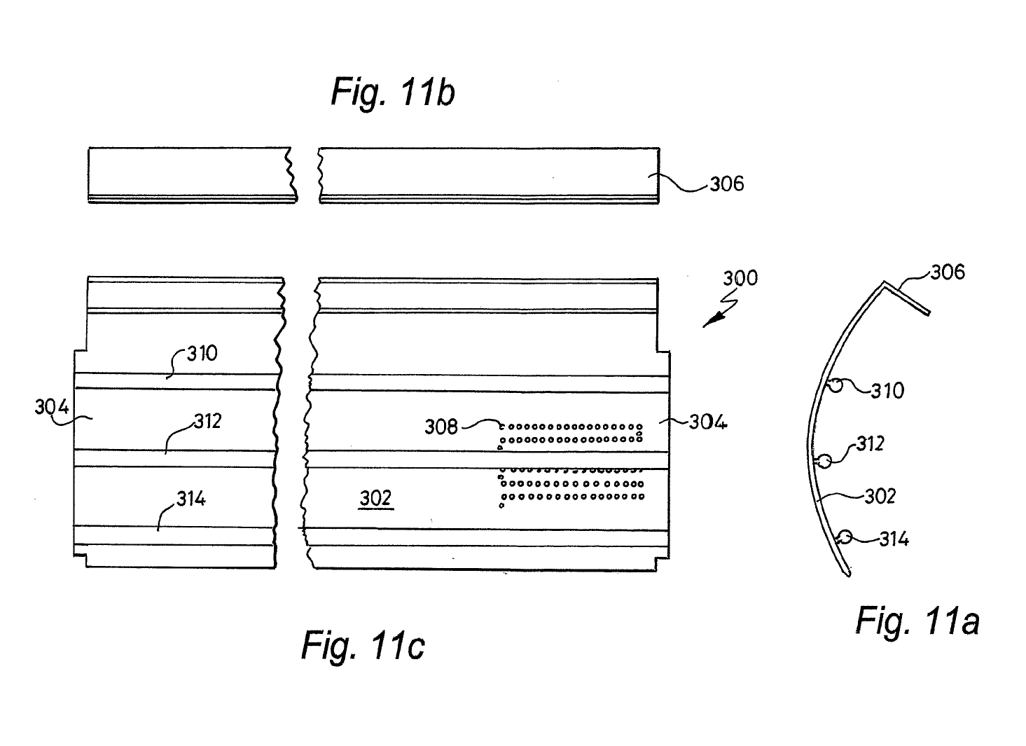

FIGS. 11a, 11b and 11c show a preferred form of the slat shown in FIGS. 3a, 3b and 3c. Each slat 300 consists of a wide curved portion 302 at the ends of which tabs 304 are formed. A flat lip portion 306 extends from, and at a right-angle to, one edge of the wide curved portion 302. The portion 302 is formed with a large number of 4 mm diameter circular holes 308 arranged so as to overlie a heater element of a heater strip that is attached to the slat. Although a plurality of such heater strips would be attached to the slat in practice, and the holes would be arranged in several serpentine patterns so as to overlie the heater elements of each of the plurality of heater strips, for the purpose of clarity only one such serpentine pattern is shown in FIG. 11c.

The portion 302 has three rails 310, 312 and 314 attached to it. In cross-section, as can best be seen in FIG. 11a, each rail consists of a narrow stem and a bulbous head. Ceramic tiles are attached to the slat by sliding the tiles along one of the rails, the rail being accommodated in a slot formed in the rear face of the tile.

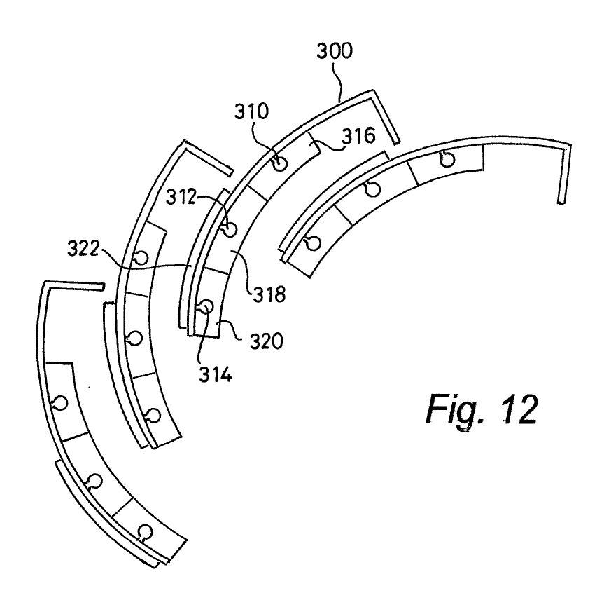

Four slats constituting part of a preferred form of vessel are shown in FIG. 12. Each rail 310, 312 and 314 has a row of ceramic tiles placed on it. One such tile of each row is visible in FIG. 12, denoted respectively reference numerals 316, 318 and 320. A ceramic cement is placed between the slat 300 and the ceramic tiles, so as to cushion the tiles against the slat. Heater strips are fastened to the opposite side of each slat to the ceramic tiles. One such heater strip is visible attached to each slat shown in FIG. 12, denoted by reference numeral 322. As previously explained, the heater strips are located so that the holes in the slats overlie the heater elements embedded in the heater strips, so as to facilitate transmission of infra-red radiation through the slat and ceramic tiles into the vessel.

Supply of electric current to the heater strips is by means of a rotary electric union attached to the outlet end of the vessel. The rotary electric union is annular such that the waveguide 58 and tubular extension 62 can pass through the rotary electric union.

A suitable rotary electric union is available from Schleifring und Apparatebau GmbH of Germany.

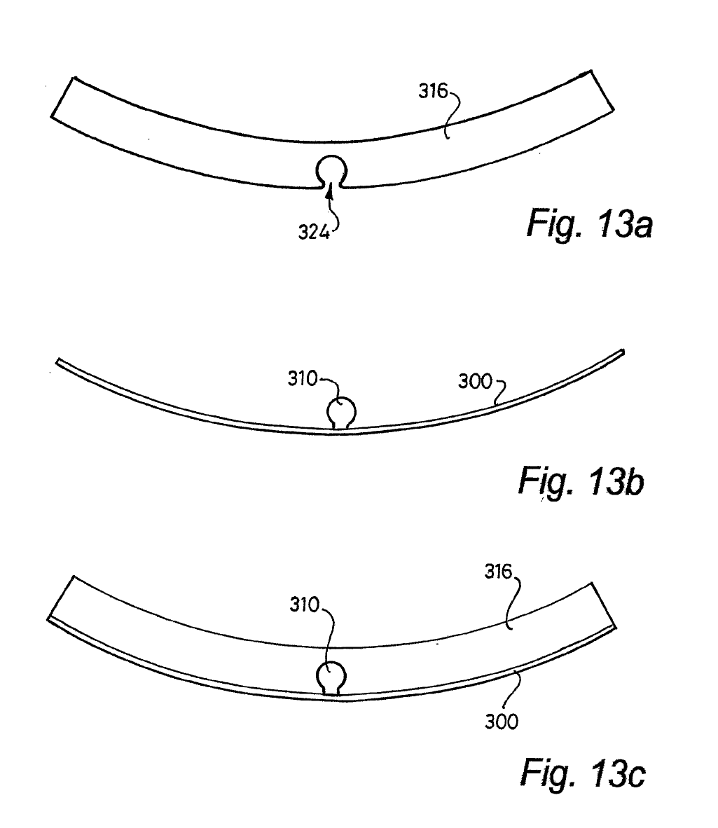

The tile 316 of FIG. 13a is not shown to scale in order clearly to show the curvature of the tile and the slot 324 that allows the tile to be attached to a slat by means of a rail. A portion of a slat 300 and rail 310 is shown in FIG. 13b, and the tile 316 attached to the slat 300 by engagement of the rail 310 in the slot 324 is shown in FIG. 13c.

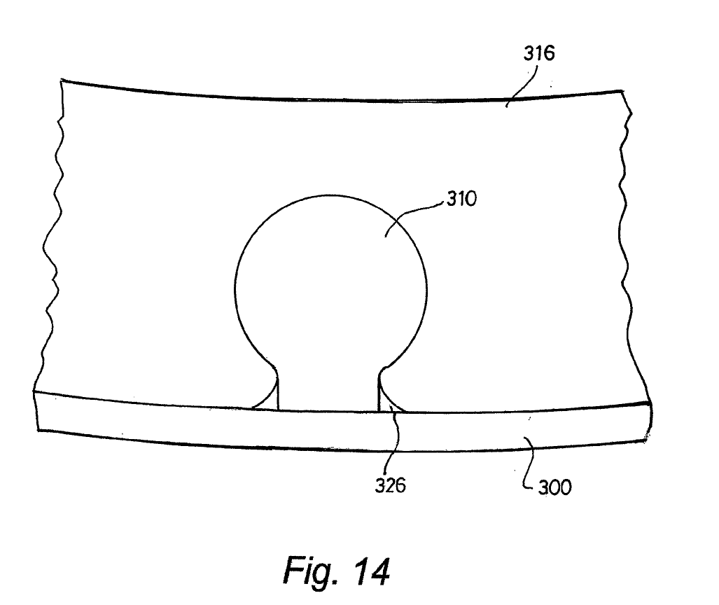

A detail of FIG. 13c is shown in FIG. 14. It can be seen that the slot has a flared portion 326 where the slot surrounds the narrow portion of the rail 310. The flared portion 326 allows for a small amount of flexure of the ceramic tile as the vessel rotates. Without the flared portion 326 stresses would be set up in the tile which might cause it to fracture.

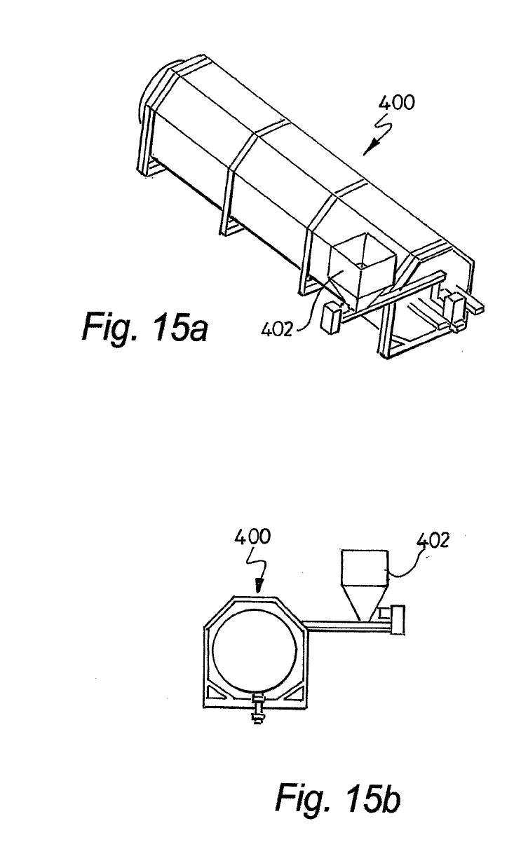

The preferred form of enclosure shown in FIGS. 15a and 15b comprises a box 400 made of 3 mm thickness steel sheet and having the form of a tube with an octagonal cross-section, the tube being split along its length into two halves with the top half being attached by hinges to the bottom half so as to form a lid.

The apparatus inside the enclosure shown in FIGS. 15a and 15b is substantially the same as that shown in, for example, in FIG. 5, except that the infra-red radiation emitter tubes and reflector have been removed because these are not required with the heater strips fitted to the slats of the vessel. A rotary electric union and source of electric current for supplying the heater strips have been added, as has a vibrating hopper 402 for delivering the feedstock into the vessel.

The box 400 is substantially gas tight and can prevent the passage of the EMR from the inside of the box to the outside. It is believed, however, that it is unnecessary for the box to prevent passage of the EMR, as the vessel forms a Faraday cage that retains all of the EMR introduced into it.

It will be appreciated that the foregoing description relates to only two embodiments of the invention, and that the invention encompasses other embodiments as defined by the foregoing statements of the invention.

1. A vessel for a feedstock that is to be heated using radio frequency electromagnetic radiation (EMR), the vessel being adapted for rotation about an axis that passes through the vessel and having an inlet aperture through which the feedstock may be introduced into the vessel and a wall for retaining the feedstock in the vessel, wherein the wall has at least one vent for venting gases released by the feedstock, the at least one vent being so formed that rotation of the vessel about the axis prevents the feedstock from entering the vent, thereby retaining the feedstock in the vessel.

2. A vessel according to claim 1, wherein the vessel is substantially reflective to the EMR.

3. A vessel according to claim 1, wherein the wall of the vessel is provided with at least one portion that is capable of absorbing the EMR.

4. A vessel according to claim 1, wherein the vessel further comprises at least one heater.

5. A vessel according to claim 1, wherein the vessel is generally cylindrical, having a generally tubular side wall and first and second generally circular end walls.

6. A vessel according to claim 5, wherein the vessel is adapted for rotation about an axis that passes through the centres of the first and second generally circular end walls.

7. A vessel according to claim 1, wherein the vessel is provided with an outlet aperture through which the feedstock may be discharged from the vessel

8. A vessel according to claim 1, wherein the vessel comprises a side wall constituted by a plurality of wall elements secured between first and second support members constituted by respective first and second end walls and a plurality of vents are formed between the plurality of wall elements.

9. A vessel according to claim 8, wherein the plurality of wall elements are slats formed with tabs and are secured between the end walls by engagement of the tabs with slots in the end walls.

10. A vessel according to claim 9, wherein the plurality of slats are secured between the end walls such that each wall element overlaps a neighbouring wall element to form an elongate vent between a portion of each slat and an overlapping portion of a neighbouring slat.

11. A vessel according to claim 10, wherein the slats are secured between the end walls such that the width of each elongate vent (as opposed to the length) is no more than one quarter of a wavelength of the EMR so that the vent forms a choke that attenuates the EMR.

12. A vessel according to claim 9, wherein the slats are formed from steel and ceramic panels attached to the surfaces of the slats that come into contact with the feedstock.

13. A vessel according to claim 12, wherein a rail extends along each slat and constitutes a tenon, and each ceramic panel is formed with a slot that constitutes a mortise, each ceramic panel being fastened to a slat by engagement of the slot with the rail.

14. A vessel according to claim 8, wherein the wall elements are provided with one or more generally radially inwardly directed blades adapted to lift the feedstock as the vessel is rotated, so as to tumble the feedstock.

15. A vessel according to claim 14, wherein the one or more blades are pivotally attached to the wall elements so as to enable the angle of the blade or blades to the axis of rotation of the vessel to be adjusted.

16. A vessel according to claim 9, wherein the slats are formed with a plurality of apertures, each aperture forming another of the plurality of vents and having a greatest dimension of no more than one quarter of a wavelength of the EMR.

17. A vessel according to claim 16, wherein the vessel further comprises at least one heater and the at least one heater is attached to an exterior face of a slat and the plurality of apertures located in the slat so as to facilitate transmission of infra-red radiation through the slat into the vessel.

18. Heating apparatus comprising a vessel according to claim 1, means for introducing a feedstock into the vessel, means for discharging the feedstock from the vessel, a source of EMR and drive means operable to rotate the vessel about an axis that passes through the vessel.

19. Heating apparatus according to claim 18, wherein the apparatus includes a further vessel according to claim 1, the first end of the further vessel being attached to the second end of the vessel such that the axis of rotation of the further vessel is collinear with the axis of rotation of the vessel.

20. Heating apparatus according to claim 18, wherein the source of EMR includes a waveguide for introducing the EMR into the vessel.

21. Heating apparatus according to claim 18, wherein the apparatus is configured to receive the vessel in a substantially horizontal orientation, such that the axis of the vessel is substantially parallel to a surface on which the apparatus rests.

22. Heating apparatus according to claim 18, wherein the apparatus includes a plurality of suction means arranged to collect gases vented from different regions of the vessel.

23. Heating apparatus according to claim 23, wherein the apparatus includes means for pumping an inert gas into the vessel, so as to prevent combustion of the feedstock as it is heated.

24. Heating apparatus according to claim 23, wherein the apparatus includes a plurality of suction means arranged to collect gases vented from different regions of the vessel and the inert gas to be pumped into the vessel is an inert gas collected by one of the plurality of suction means.

25. A method of heating a feedstock using EMR, the method comprising the steps of delivering a feedstock into a vessel according to claim 1, directing EMR at and/or introducing EMR into the vessel and rotating the vessel so as to tumble the feedstock.

26. A method according to claim 25, wherein the method further includes the step of delivering into the vessel a material that interacts with the EMR.

27. A method according to claim 25, wherein the method further comprises the step of supplying a heated fluid or electric current from a source of heated fluid or electric current through a rotary union to a heater attached to the vessel.

28. A method according to claim 25, wherein the method includes the step of collecting flammable gases released from the feedstock and burning them in a boiler or gas turbine to drive an electric generator.
